(19) United States
(12) Patent Application Publication
(10) Pub. No.: US 2025/0139432 A1
(43) Pub. Date: May 1, 2025

(54) MERGING ELEMENTS OF SEQUENCES DURING NEURAL NETWORK PROCESSING

(71) Applicant: Google LLC, Mountain View, CA (US)

(72) Inventors: Cédric Benjamin Renggli, Uster (CH); Carlos Riquelme Ruiz, Zurich (CH); André Susano Pinto, Zürich (CH); Basil Mustafa, Zurich (CH); Joan Puigcerver i Perez, Zurich (CH); Neil Matthew Tinmouth Houlsby, Zurich (CH)

(21) Appl. No.: 18/835,613

(22) PCT Filed: Feb. 6, 2023
(86) PCT No.: PCT/US2023/012425

§ 371 Date: Aug. 2, 2024

Related U.S. Application Data
(60) Provisional application No. 63/306,995, filed on Feb. 4, 2022.

(51) Int. Cl. G06N 3/08

(52) U.S. Cl. CPC G06N 3/08

(57) ABSTRACT

Methods, systems, and apparatus, including computer programs encoded on a computer storage medium, for performing a machine learning task on a network input to generate a network output. In one aspect, one of the systems includes a neural network configured to perform the machine learning task, the neural network including one or more merger neural network blocks that each generate block output sequence that has fewer elements than the block input sequence that is processed by the merger neural network block.

### CROSS-REFERENCE TO RELATED APPLICATIONS

This application claims the benefit of priority to U.S. Provisional Application Ser. No. 63/306,995, filed Feb. 4, 2022, the entirety of which is incorporated herein by reference.

### BACKGROUND

This specification relates to performing a machine learning task on a network input using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that executes a neural network that has been configured through training to process an input sequence that includes a respective input element at each of multiple input positions, and to generate a network output representing a prediction about the input sequence.

The neural network includes a sequence of one or more network blocks that are each configured to process a block input sequence, e.g., the input sequence or an intermediate representation of the input sequence, to generate a block output sequence.

At least one of the blocks is a “merger” neural network block. Each merger network block is configured to generate a block output sequence having the same number M of block output elements regardless of a number N of block input elements in the block input sequence to the merger network block. The merger network block can generate the block output sequence by “merging” the N block input elements of the block input sequence to generate the M block output elements by performing one or more learned operations. In particular, the merger network block can improve the computational and time efficiency of subsequent network blocks in the sequence by reducing the number of elements in the block input sequence, i.e., M<N.

Particular embodiments of the subject matter described in this specification can be implemented so as to realize one or more of the following advantages.

Using techniques described in this specification, a system can improve the computational efficiency of a neural network configured to process an input sequence and to generate a network output representing the input sequence. The system can achieve this improved efficiency by inserting, into the network architecture of the neural network, one or more merger network blocks that reduce the time and computational resources required to process the input sequence. In particular, at each merger network block in the neural network, the system can reduce the number of elements in a block input sequence generated from the input sequence by “merging” the elements of the block input sequence to generate a block output sequence having fewer elements than the block input sequence. Thus, because the subsequent neural network layers that follow the merger network block in the network architecture process intermediate sequences (i.e., either the block output sequence or an intermediate sequence generated from the block output sequence) having fewer elements than if the merger network block were not inserted into the neural network, the subsequent neural network layers can spend significantly less time and fewer computational resources to generate the network output.

Each merger network block can be configured through training to encode maximal information from the block input sequence into the block output sequence. Thus, although the block output sequence includes fewer elements than the block input sequence, the block output sequence can still encode the information from the block input sequence required for the neural network to generate an accurate network output. In other words, using techniques described in this specification, a system can reduce the computational costs of generating a network output while achieving comparable performance (e.g., as measure by prediction accuracy) or even, in some implementations, improved performance relative to neural networks that do not include such merger network blocks.

As a particular example, a neural network that executes a merger network block as described in this specification can reduce the runtime of the neural network and/or the floating point operations (FLOPs) required to execute the neural network by 40%, 50%, or 60%. In some implementations, these efficiency gains can be used to add more neural network layers to the neural network, improving the performance (e.g., as measured by prediction accuracy) of the neural network. In other words, for a fixed compute budget, inserting merger network blocks into a neural network as described herein can significantly improve the quality of network outputs generated by the neural network.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system.

FIG. 2 shows an example of the operation of a merger network block.

FIG. 3 is a flow diagram of an example process for processing an input sequence using a merger block.

FIGS. 4 and 5 show the performance of various neural network architectures with and without merger network blocks.

Like reference numbers and designations in the various drawings indicate like elements.

### DETAILED DESCRIPTION

This specification describes a system implemented as computer programs on one or more computers in one or more locations that performs a machine learning task on a network input to generate a network output for the machine learning task using a neural network that includes one or more merger network blocks.

The machine learning task can be any machine learning task that operates on a network input that is an input sequence, i.e., a collection of multiple elements, to generate a network output for the network input.

Some examples of machine learning tasks that the system can be configured to perform follow.

For example, the input sequence can represent an input image, and the machine learning task may be an image processing task. The neural network can be configured to process images of any appropriate type, e.g., RGB images, LIDAR images (e.g., point clouds), and so on. The system can divide the image into multiple different image patches, where each image patch includes a different subset of the pixels of the image. The input elements of the input sequence can thus represent respective image patches of the input image. In this specification, processing an image refers to processing the intensity values of the pixels of the image.

In other words, when the input is an image or point cloud, the neural network can include an embedding subnetwork that generates a respective embedding for each multiple patches of the image or point cloud, and the input to the first block of the neural network can be a sequence that includes the respective embeddings (and, optionally, one or more additional embeddings, e.g., at a predetermined position that will later be used to generate the output). Each patch includes the intensity values of the pixels in a different region of the input image.

As a particular example, the neural network can be configured to generate a classification output that includes a respective score corresponding to each of multiple categories. The score for a category indicates a likelihood that the network input belongs to the category. In some cases, the categories may be classes of objects (e.g., dog, cat, person, and the like), and the network input may belong to a category if it represents an object included in the object class corresponding to the category. In some cases, the categories may represent global properties (e.g., whether the network input represents an environment in the day or at night, or whether the network input represents an environment in the summer or the winter), and the network input may belong to the category if it has the global property corresponding to the category.

As another particular example, the neural network can be configured to generate an element-level classification output (e.g., a pixel-level classification output for an RGB image or a point-level classification output for a LIDAR image) that includes, for each element in the network input, a respective score corresponding to each of multiple categories. For a given element (e.g., for a given pixel or point), the score for a category indicates a likelihood that element belongs to the category. In some cases, the categories may be classes of objects, and an element may belong to a category if it is part on an object included in the object class corresponding to the category. That is, the element-level classification output may be semantic segmentation output.

As another example, the task can be a depth prediction task. In a depth prediction task, the output generated by the neural network identifies, for each pixel in the image, a predicted depth of the scene at the pixel.

As another example, the task can be a surface normal prediction task. In a surface normal prediction task, the output generated by the neural network identifies, for each pixel in the image, a predicted surface normal of the scene at the pixel.

As another particular example, the neural network can be configured to generate a regression output that estimates one or more continuous variables (i.e., that can assume infinitely many possible numerical values) that characterize the network input. In a particular example, if the network input represents an image, the regression output may estimate the coordinates of bounding boxes that enclose respective objects depicted in the image. The coordinates of a bounding box may be defined by (x, y) coordinates of the vertices of the bounding box.

As another example, the task may be an audio processing task. For example, the network input can represent a sequence of audio data, and the machine learning task may be a speech recognition task, where the neural network is configured to process a representation of an audio waveform to generate an output that characterizes a sequence of phonemes, characters, or words corresponding to the audio waveform. As another example, if the input to the neural network is a sequence representing a spoken utterance, the output can be a classification output that classifies the spoken utterance into one or more categories from a set of categories. As another example example, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can identify the natural language in which the utterance was spoken.

As another example, the network input can represent a sequence of video frames, and the machine learning task may be a video analysis task, where the neural network is configured to process a sequence of video frames to generate an output that characterizes the video frames, e.g., by characterizing whether the video frames depict a person performing a particular action.

As another example, the network input can represent a sequence of text data, and the machine learning task may be a natural language processing task, where the neural network is configured to process a portion of text to generate an output that characterizes the portion of text, e.g., by characterizing a translation of the portion of text into a different natural language.

As a particular example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another particular example, the task can be a text generation task, where the input is a sequence of text, and the output is another sequence of text, e.g., a completion of the input sequence of text, a response to a question posed in the input sequence, or a sequence of text that is about a topic specified by the first sequence of text. For instance, the neural network can be an autoregressive neural network, e.g., a self-attention based autoregressive neural network. As another example, the input to the text generation task can be an input other than text, e.g., an image, and the output sequence can be text that describes the input.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be an agent control task, where the input is a sequence of observations or other data characterizing states of an environment and the output defines an action to be performed by the agent in response to the most recent data in the sequence. The agent can be, e.g., a real-world or simulated robot, a control system for an industrial facility, or a control system that controls a different kind of agent.

As another example, the task can be a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some implementations, the task is a multi-modal task that requires processing both text and image inputs, so that the neural network includes both a computer vision neural network and a text processing neural network. That is, the target output to be generated by the computer vision neural network for a given image depends on one or more outputs generated by the text processing neural network for one or more corresponding text inputs (and vice versa). Examples of such tasks include open-vocabulary image classification, open-vocabulary object detection, image captioning, text-based image search, image-based retrieval, and so on.

In some cases, the machine learning task is a combination of multiple individual machine learning tasks, i.e., the system is configured to perform multiple different individual machine learning tasks, e.g., two or more of the machine learning tasks mentioned above. For example, the system can be configured to perform multiple individual natural language understanding tasks, with the network input including an identifier for the individual natural language understanding task to be performed on the network input.

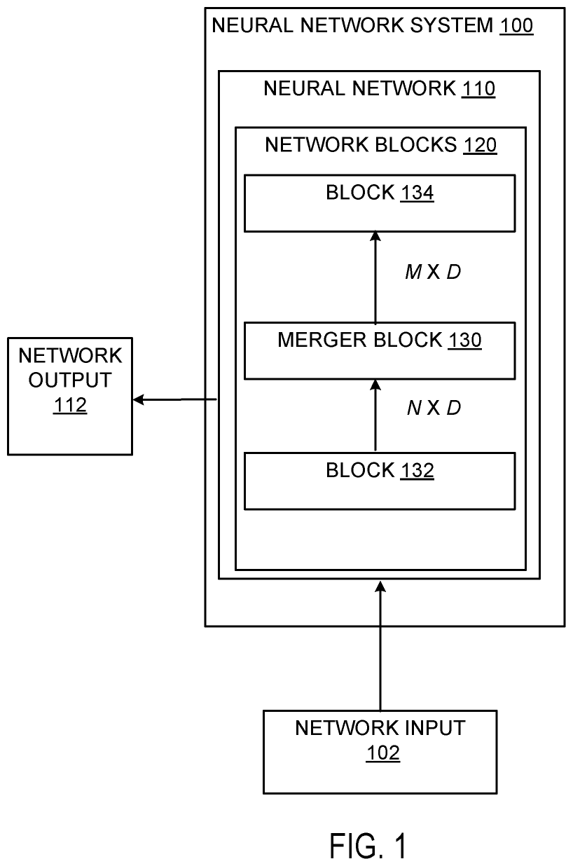

FIG. 1 shows an example neural network system 100. The neural network system 100 is an example of a system implemented as computer programs on one or more computers in one or more locations, in which the systems, components, and techniques described below can be implemented.

The system 100 processes a network input 102 using a neural network 110 to generate a network output 112 characterizing the network input 102 for a machine learning task, e.g., one of the tasks described above.

The neural network 110 includes a sequence of network blocks 120 that are each configured to process a block input that includes the network input or an intermediate representation of the network input and to generate a block output.

A “network block,” as used in this specification, is a collection of one or more neural network layers that receive an input (“a block input”) and process the input to generate an output (a “block output”).

For example, the first network block in the sequence of network blocks 120 can process the network input 102 or embeddings of the network input generated by an embedding subnetwork to generate a block output that is an intermediate representation of the network input. Each subsequent network block 120 can then process the block output of the previous network block in the sequence.

In some implementations, the network output 112 for the neural network 110 is the block output of the final network block 120 in the sequence.

In some other implementations, the block output of the final network block 120 in the sequence is further processed using one or more output neural network layers to generate the network output 112 for the neural network 110.

The sequence of network blocks includes one or more “merger” network blocks 130. For example, FIG. 1 shows that there is merger network block 130 between blocks 132 and 134 in the sequence of network blocks 120.

Each merger network block 130 is configured to generate a block output sequence having the same number (M) of block output elements at respective block output positions from a larger number (N) of block input elements at respective block input positions in the block input sequence to the merger network block. In particular, the merger network block 130 can be configured to generate a sequence with a fixed number M of block output elements no matter how large the number of input elements is in the block input sequence.

For example, when the elements at each position are D dimensional vectors, the input to a merger block 130 can be N×D while the output of the merger block 130 is M×D.

The merger network block 130 can generate the block output sequence by “merging” the N block input elements of the block input sequence to generate the M block output elements. In particular, the merger network block 130 can improve the computational and time efficiency of subsequent network blocks in the sequence by reducing the number of elements in the block input sequence, i.e., M<N.

In some implementations, the sequence of network blocks 120 includes multiple merger network blocks 130 and each merger network block can have a respective different value for M, i.e., generate block output sequences having respective different lengths.

More specifically, while in some implementations, the neural network 110 includes only a single merger block 130, in some other implementations the sequence of network blocks 120 includes multiple merger network blocks 130, with each merger network block 130 generating block output sequences having successively smaller lengths, further improving the efficiency of the neural network. That is, for each particular merger network block 130 in the neural network, the particular merger network block 130 can be configured to generate a block output sequence having a shorter length (i.e., fewer block output elements) than the respective block output sequences of any other merger network blocks 130 that precede the particular merger network block 130 in the sequence of network blocks 120.

Generally, each merger network block 130 can receive block input sequences having any number of block input elements, and generate a fixed-length block output sequence. Thus, the computational cost of the neural network layers following the merger network blocks can be constant, regardless of the length of the input sequence to the neural network.

As a particular example, the neural network 110 can process an input sequence that includes more than 40 elements, e.g., 49, 196, or 256 elements, and use a single merger neural network block 130 to reduce the number of elements to 8. Thus, each component after the single merger neural network block 130 only needs to process an input sequence having 8 elements, significantly improving the computational efficiency of the neural network 110 relative to one that does not have any merger neural network blocks 130 and therefore requires all of the blocks in the sequence 120 to process an input sequence that includes more than 40 elements.

In some implementations, the neural network 110 includes a respective layer normalization neural network layer before each merger network block 130 (e.g., the layer normalization neural network layer can be the final neural network layer in the preceding network block in the sequence of network blocks 120). The layer normalization layer can process an initial block input sequence having a respective initial block input element at each of the N block input positions by applying layer normalization to each initial block input element in the initial block input sequence to generate the block input sequence for the merger network block.

The sequence of network blocks 120 generally includes one or more network blocks 120 that are not merger network blocks and that preserve the number of inputs in the input sequence to the network block 120.

For example, the sequence of network blocks 120 can include one or more self-attention network blocks that are each configured to apply a self-attention mechanism to the block input elements of the block input sequence to the self-attention network blocks. In particular, for each block input element, the self-attention network block can apply the attention mechanism over the sequence of block input elements using one or more queries derived from the block input element to generate a respective block output element. Thus, the self-attention network block can preserve the number of block input elements in the block input sequence to the self-attention network block. In other words, the block output sequence of the self-attention network block can have the same number of block output elements as the number of block input elements in the block input sequence.

A self-attention neural network layer receives as input a sequence of input elements and applies an attention mechanism over the sequence of input elements to generate a sequence of layer outputs elements. In particular, for each input element, the self-attention neural network layer applies the attention mechanism over the sequence of input elements using one or more queries derived from the input element to generate a respective output element. Some self-attention neural network layers are multi-head self-attention neural network layers. A multi-head self-attention neural network layer applies h different attention mechanisms in parallel to generate respective sequences of output elements, and then combines the multiple sequences of output elements to generate a final sequence of output elements.

Thus, when the sequence of network blocks includes a self-attention network block that is configured to perform operations that include obtaining a second block input sequence having a respective second block input element at only each of P second block input positions, P>1; and applying self-attention to the second block input sequence to generate a second block output sequence having a respective second block output element at only each of P second block output positions. When the self-attention network block is before the merger block 130 shown in FIG. 1, P=N, but when the self-attention network block is after the merger block 130 shown in FIG. 1, P=M. Since M is less than N, self-attention blocks after the merger block 130 only need to perform self-attention over smaller sequence as a result of the merger block 130 being included in the sequence 120.

Self-attention is described in more detail below.

Instead or in addition, the sequence of network blocks 120 can include one or more expert network blocks that are each configured to process the block input sequence to the expert network block using multiple different expert subnetworks. In particular, for each expert subnetwork, the expert network block can select one or more block input elements of the block input sequence to be processed by the expert subnetwork, generating a respective sub-output for each block input element. For each block input element, the expert network block can then generate a respective block output element by combining any sub-outputs generated by respective expert subnetworks in response to processing the block input element. Thus, the expert network block can preserve the number of block input elements in the block input sequence to the expert network block. In other words, the block output sequence of the expert network block can have the same number of block output elements as the number of block input elements in the block input sequence.

In some implementations, the expert network block executes “element-choice” routing, where, for each block input element, the expert network block generates a respective score for each expert subnetwork, and assigns the block input element to the expert network blocks with the highest score. In some other implementations, the expert network block executes “subnetwork-choice” routing, where, for each expert subnetwork, the expert network block generates a respective score for each block input element, and assigns the block input elements with the highest score to the expert network block.

Thus, when the sequence of network blocks includes an expert network block, an example set of operations performed by the expert network block can include obtaining a third block input sequence having a respective third block input element at only each of Q third block input positions (Q>1) and, for each of a plurality of expert subnetworks of the expert network block determining a subset of the third block input elements.

The expert block then, for each of the expert subnetworks and for each third block input element in the subset determined for the expert subnetwork, processes the third block input element using the expert subnetwork to generate a respective sub-output. The expert block can then generate a third block output sequence having a respective third block output element at only each of Q third block output positions by, for each third block input element, determining a respective third block output element from the sub-outputs generated from the third block input element.

When the expert network block is before the merger block 130 shown in FIG. 1, Q=N, but when the expert network block is after the merger block 130 shown in FIG. 1, Q=M. Since M is less than N, expert blocks after the merger block 130 need to route fewer elements among the various expert neural networks as a result of the merger block 130 being included in the sequence 120.

More generally, the neural network can include any combination of network blocks, e.g., any combination of self-attention network blocks, network blocks that perform other types of attention (e.g., cross-attention), and expert network blocks, in addition to the one or more merger network blocks 130.

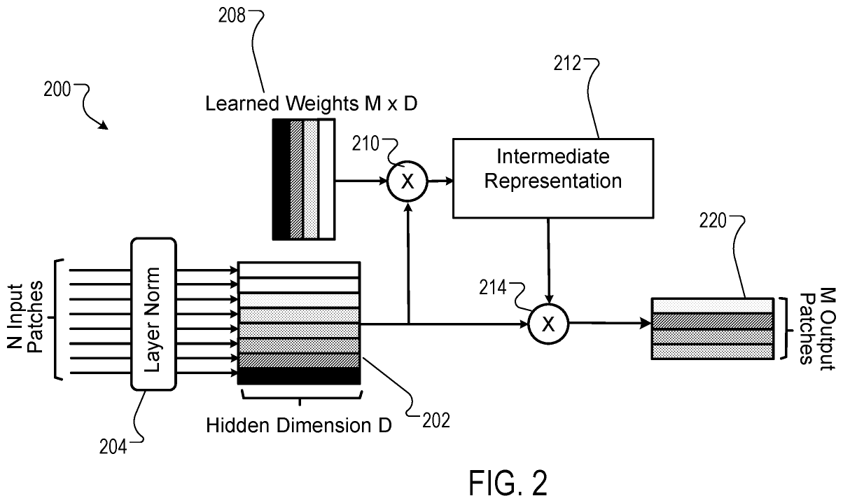

FIG. 2 shows the operations performed by a merger network block 130.

As shown in FIG. 2, the merger network block 130 receives a block input text use z, 21 sequence 202 that includes ND-dimensional vectors. Thus, the block input sequence 202 can be represented as an input matrix X∈ [symbol] ^{N×D}, where each row of the input matrix X represents a respective block input element xⱼ∈ [symbol] ^{D}, j∈[1, . . . , N].

Prior to providing the block input sequence 202 to the merger network block 130, the neural network 130 applies layer normalization (“Layer Norm”) 204 to each element in the block input sequence 202 to normalize the elements of the block input sequence 202. For example, the layer normalization layer 204 can be the last layer of the preceding network block or can be inserted between the two network blocks within the sequence of network blocks 120.

Thus, the layer normalization layer 204 is configured to perform operations that include obtaining an initial block input sequence having a respective initial block input element at only each of the N block input positions; and applying layer normalization to each initial block input element in the initial block input sequence to generate the block input sequence.

The merger network block 130 can then generate a block output sequence 220 that includes MD-dimensional output vectors. Thus, the block output sequence 220 can be represented as an output matrix Y∈ [symbol] ^{M×D}, where each row of the output matrix Y represents a respective block output element yᵢ∈ [symbol] ^{D}, i∈[1, . . . , M].

More specifically, the merger network block 130 can process the block input sequence 202 to generate an intermediate representation 212 that includes, for each block output position, a respective score corresponding to each block input position. That is, the intermediate representation 212 includes a respective score for each pair of (block input position j, block output position i). The intermediate representation 212 can be represented as a matrix S∈ [symbol] ^{M×N} where each element s_{i,j} of S represents the score corresponding to the i^{th} block output position and the j^{th} block input position.

The merger network block 130 can apply 210 a learned weight matrix W∈ [symbol] ^{D×M} 208 to the block input sequence X to generate the intermediate representation S 212. In particular, the merger network block 130 can generate the intermediate representation by computing:

S=(XW)^{T}

Equivalently, the merger network block 130 can generate the intermediate representation by computing:

S=W^{T}X^{T}

The merger network block 130 can then apply 214 the intermediate representation 212 to the block input sequence 202 to generate the block output sequence. For example, the merger network block can compute:

Y=SX

Alternatively, the merger network block can compute:

Y=softmax(S)X

where the softmax 212 is applied independently for each input element, i.e., independently for each column of S.

Thus, each block output element is a weighted sum of the block input elements. For each block input element, the respective weight in the weighted sum is equal to (or generated from, in implementations in which a softmax is applied) the score, in the intermediate representation 212, corresponding to the block input element and the block output element, as determined by applying the learned weight matrix 208 to the block input sequence.

Because the number of parameters of the merger block 130, i.e., the dimensions of the learned weight matrix 208, do not depend on the number of input elements N but only depend on the number of output elements M, the merger block 130 can be used to map variable numbers of input elements to the same fixed number (M) of output elements.

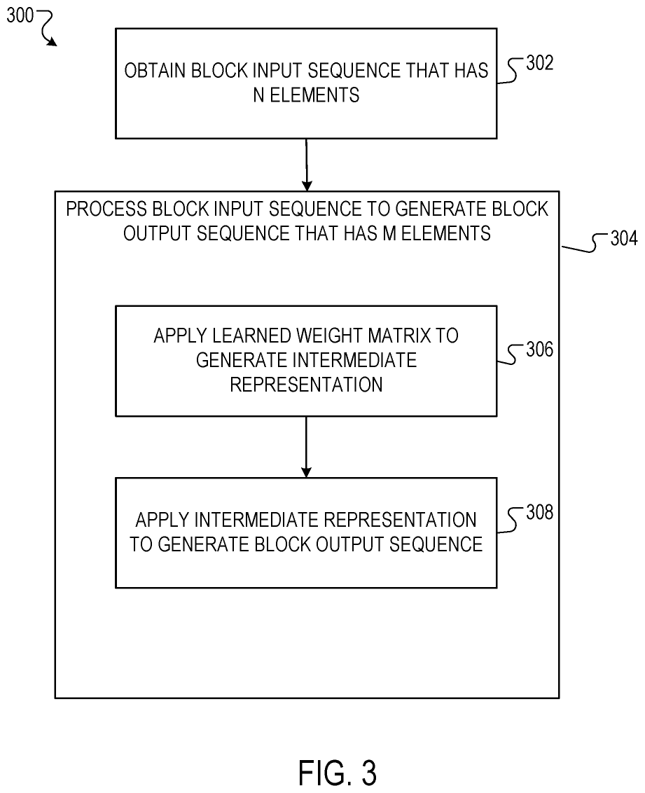

FIG. 3 is a flow diagram of an example process 300 for processing a block input sequence using a merger block. For convenience, the process 300 will be described as being performed by a system of one or more computers located in one or more locations. For example, an expert block included in a neural network system, e.g., one of the expert blocks 130 included in the neural network system 100 of FIG. 1, appropriately programmed, can perform the process 200.

The merger block obtains a block input sequence that represents an intermediate representation of the network input (step 302). In particular, the block input sequence has a respective block input element at only each of N block input positions, wherein N>1. That is, the block input sequence has exactly N input elements.

More specifically, when the input sequence represents an input image, at least some of the input elements in the block input sequence represent respective image patches determined from the input image.

When the input sequence represents an input text, and at least some of the input elements represent respective text tokens determined from the input text.

When the input sequence represents audio data, at least some of the input elements represent respective audio tokens determined from the audio data.

The merger block processes the block input sequence to generate a block output sequence having a respective block output element at only each of M block output positions, wherein N>M>1 (step 304). That is, the merger block reduces the number of elements from N to M.

As part of processing the block input sequence, the block applies a learned weight matrix to the block input sequence to generate an intermediate representation (step 306). As described above, the intermediate representation includes, for each block output position, a respective score corresponding to each block input position.

The block then applies the intermediate representation to the block input sequence to generate the block output sequence (step 308). By applying the intermediate representation to the block input sequence, the block reduces the number of elements in the block input sequence while propagating relevant information from the N elements in the input sequence across the M elements in the output sequence.

Prior to using the neural network to perform the machine learning task, a training system trains the neural network to perform the task, i.e., to determine trained values of the parameters of the neural network, i.e., of the blocks in the sequence, and, optionally, an embedding subnetwork used to generate the input to the first block in the sequence, an output subnetwork that generates the network output from the output of the last block in the sequence, or both. For example, the training system can train the neural network from scratch on training data for the task to minimize a loss function for the task, e.g., a cross-entropy loss, a negative log likelihood loss, and so on using conventional machine learning techniques. As another example, the training system can first pre-train the neural network on an unsupervised objective and then fine-tune the neural network on the training data for the task. As yet another example, the training system can train the neural network on both unlabeled data and the training data for the task through semi-supervised learning.

During training, the training system can incorporate any number of techniques to improve the speed, the effectiveness, or both of the training process. For example, the system can use dropout, label smoothing, or both to reduce overfitting. As another example, the system can perform the training using a distributed architecture that trains multiple instances of the neural network in parallel. Moreover, as described above, the system can first pre-train the neural network on a large unsupervised data set through unsupervised learning, e.g., to minimize a BERT loss or other unsupervised loss, and then fine-tune the neural network on task-specific training data to optimize the loss function for the task.

By virtue of the training, each merger block in the sequence becomes configured, i.e., by learning the weights of the weight matrix that is applied by the merger block to determine the intermediate representation based on gradients of the overall loss, to encode maximal information from the block input sequence into the block output sequence. Thus, although the block output sequence includes fewer elements than the block input sequence, the block output sequence can still encode the information from the block input sequence required for the neural network to generate an accurate network output. In other words, using techniques described in this specification, a system can reduce the computational costs of generating a network output while achieving comparable performance (e.g., as measure by prediction accuracy) or even, in some implementations, improved performance relative to neural networks that do not include such merger network blocks.

Moreover, in some cases, as a result of the above training, the neural network has been pre-trained on a machine learning task that is different from the machine learning task for which the neural network is currently configured when performing inference. That is, the neural network can be configured to perform inference to generate a network output that represents a first type of prediction about the input sequence, and can have been pre-trained to generate a network output that represents a second type of prediction about the input sequence.

In some such implementations, the input sequences for the inference machine learning task can be longer (i.e., include more input elements) than the input sequences for the pre-training machine learning task. That is, the neural network can be pre-trained to process input sequences that are shorter than the input sequences for which the neural network will eventually be configured. In particular, the merger network blocks can be configured to process block input sequences that are longer than the block input sequences on which the merger network block has been trained, without harming the performance of the neural network, e.g., without reducing the prediction accuracy of the network outputs generated by the neural network.

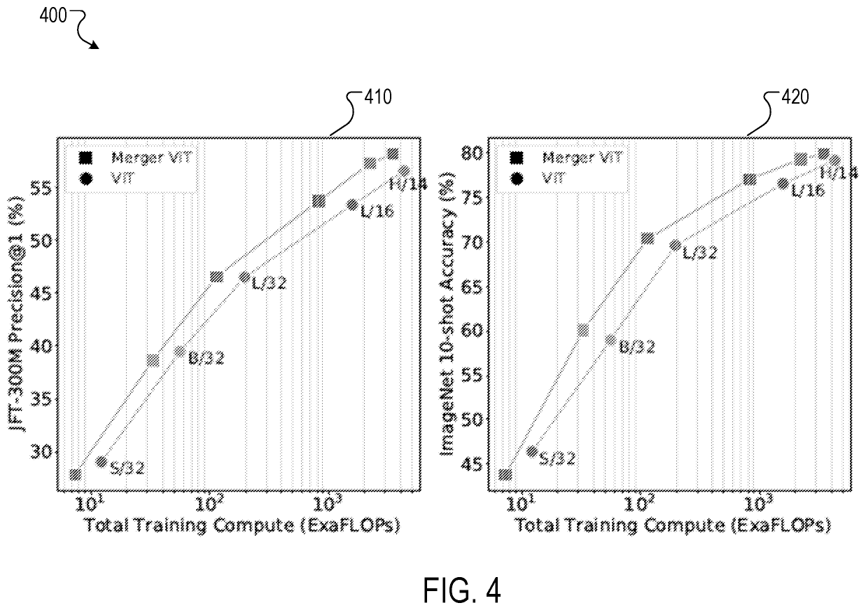

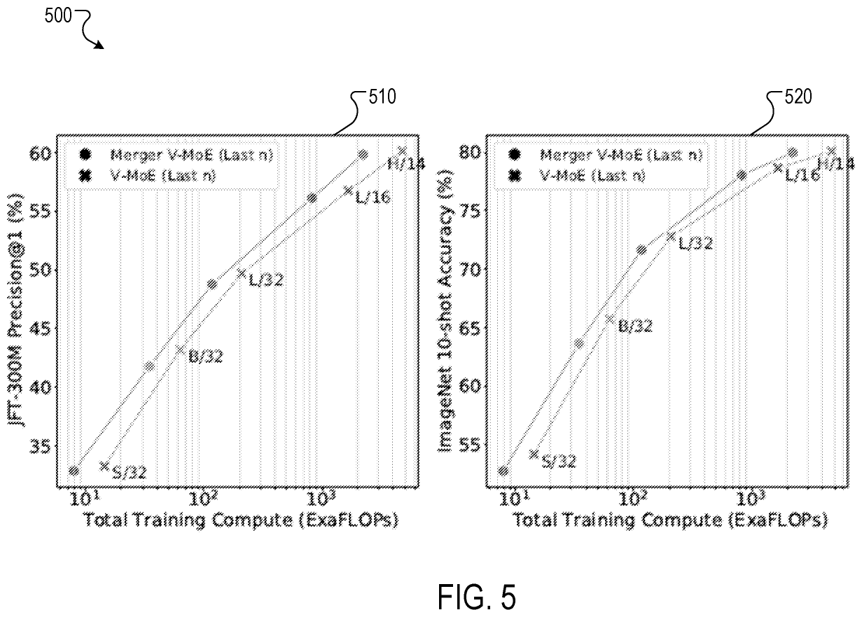

FIGS. 4 and 5 show the performance of various neural network architectures with and without merger network blocks.

In particular, FIGS. 4 and 5 shows various plots that each have total training compute (measured in ExaFLOPs) on the x axis and a corresponding performance measure, e.g., accuracy or precision, on the y axis.

In particular, FIG. 4 shows an example 400 of the performance of various Vision Transformer (ViT) architectures, with and without a single merger network block added in the middle of the network. Architectures without a merger block are depicted using circles while architectures with a merger block are depicted with squares.

The plot 410 shows the precision (@1) on the JFT-300M task on the y axis relative to the ExaFLOPs on the x axis.

The plot 420 shows the 10-shot accuracy (measured as a percentage) on the ImageNet 10-shot task relative to the ExaFLOPs on the x axis.

As can be seen from the plots 410 and 420, each “Merger ViT” obtains comparable—sometimes even better—performance than its corresponding ViT model with a much lower cost.

FIG. 5 shows an example 500 of the performance of various Vision Mixture of Experts (V-MoE) architectures, with and without a single merger network block added in the middle of the network. Architectures without a merger block are depicted using crosses while architectures with a merger block are depicted with hexagons.

The plot 510 shows the precision (@1) on the JFT-300M task on the y axis relative to the ExaFLOPs on the x axis.

The plot 520 shows the 10-shot accuracy (measured as a percentage) on the ImageNet 10-shot task relative to the ExaFLOPs on the x axis.

As can be seen from the plots 510 and 520, each “Merger V-MoE” obtains comparable—sometimes even better—performance than its corresponding V-MoE model with a much lower cost. In particular, the Merger V-MoEs save around 50% of the FLOPs relative to their V-MoE counterparts with comparable or better performance.

While FIGS. 4 and 5 show the cost in terms of training compute, it should be understood that both training and inference require a forward pass through the neural network to generate a network output for a network input, and that “inference” compute, i.e., i.e., the number of FLOPs required to generate a network output for a network input, will be similarly reduced as a result of including one or more merger network blocks.

An “embedding,” as used in this specification is a vector of numeric values, e.g., floating point or other type of numeric values, that has a predetermined dimensionality, e.g., has a predetermined number of values.

A self-attention block, as referred to above, is a neural network layer that includes an attention mechanism that operates over the self-attention block input (or an input derived from the layer input) to generate the self-attention block output. A self-attention mechanism may be causally masked so that any given position in an input sequence does not attend over (e.g. use data from) any positions after the given position in the input sequence. There are many different possible attention mechanisms. Some examples of self-attention layers including attention mechanisms, are described in Vaswani et al. “Attention is all you need”, 31st Conference on Neural Information Processing Systems (NIPS 2017), Long Beach, CA, USA; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020.

Generally, an attention mechanism maps a query and a set of key-value pairs to an output, where the query, keys, and values are all vectors. The output is computed as a weighted sum of the values, where the weight assigned to each value is computed by a compatibility function, e.g. a dot product or scaled dot product, of the query with the corresponding key.

Generally, a self-attention mechanism is configured to relate different positions in the same sequence to determine a transformed version of the sequence as an output. For example the attention layer input may comprise a vector for each element of the input sequence. These vectors provide an input to the self-attention mechanism and are used by the self-attention mechanism to determine a new representation of the same sequence for the attention layer output, which similarly comprises a vector for each element of the input sequence. An output of the self-attention mechanism may be used as the attention layer output, or it may be processed by one or more of feed-forward layers, skip connections, or normalization operations to provide the attention layer output.

In some implementations the attention mechanism is configured to apply each of a query transformation e.g. defined by a matrix W^{Q}, a key transformation e.g. defined by a matrix W^{K}, and a value transformation e.g. defined by a matrix WV, to the attention layer input which is the input data X to the attention layer, to derive a query matrix Q=XW^{Q} that includes a respective query for each vector in the input sequence, key matrix K=XW^{K} that includes a respective key for each vector in the input sequence, and value matrix V=XW^{V} that includes a respective value for each vector in the input sequence, which are used determine an attended sequence for the output. For example the attention mechanism may be a dot product attention mechanism applied by applying each query vector to each key vector to determine respective weights for each value vector, then combining the value vectors using the respective weights to determine the self-attention layer output for each element of the input sequence. The self-attention layer output may be scaled by a scaling factor e.g. by the square root of the dimensions of the queries and keys, to implement scaled dot product attention. Thus, for example an output of the attention mechanism may be determined as softmax

$$( \frac{{QK}^{T}}{\sqrt{d}} ) V$$

where d is a dimension of the key (and value) vector. In another implementation the attention mechanism be comprise an “additive attention” mechanism that computes the compatibility function using a feed-forward network with a hidden layer. The output of the attention mechanism may be further processed by one or more fully-connected, feed forward neural network layers.

The attention mechanism may implement multi-head attention, that is, it may apply multiple different attention mechanisms in parallel. The outputs of these may then be combined, e.g. concatenated, with a learned linear transformation applied to reduce to the original dimensionality if necessary.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A system comprising a neural network that is configured to process an input sequence comprising a respective input element at each of a plurality of input positions and to generate a network output representing the input sequence,
the neural network comprising a sequence of one or more network blocks, the sequence comprising a merger network block configured to perform operations comprising:
obtaining a block input sequence having a respective block input element at only each of N block input positions, wherein N>1; and
processing the block input sequence to generate a block output sequence having a respective block output element at only each of M block output positions, wherein N>M>1,
the processing comprising:
applying a learned weight matrix to the block input sequence to generate an intermediate representation comprising, for each block output position, a respective score corresponding to each block input position, and
applying the intermediate representation to the block input sequence to generate the block output sequence.

2. The system of claim 1, wherein:
the block input sequence is represented as an input matrix X∈ [symbol] ^{N×D}, wherein each row of the input matrix represents a respective block input element xⱼ∈ [symbol] ^{D}, j∈[1, . . . , N].

3. The system of claim 1, wherein:
the block output sequence is represented as an output matrix Y∈ [symbol] ^{M×D}, wherein each row of the output matrix represents a respective block output element yᵢ∈ [symbol] ^{D}, i∈[1, . . . , M].

4. The system of claim 1, wherein:
applying a learned weight matrix to the block input sequence to generate an intermediate representation comprises computing:
S=(XW)^{T}
wherein X∈ [symbol] ^{N×D} represents the block input sequence, W∈ [symbol] ^{D×M} represents the learned weight matrix, S∈ [symbol] ^{M×N} represents the intermediate representation, and each element s_{i,j} of S represents the score corresponding to the i^{th} block output position and the j^{th} block input position.

5. The system of claim 1, wherein:
applying a learned weight matrix to the block input sequence to generate an intermediate representation comprises computing:
S=W^{T}X^{T}
wherein X∈ [symbol] ^{N×D} represents the block input sequence, W∈ [symbol] ^{D×M} represents the learned weight matrix, S∈ [symbol] ^{M×N} represents the intermediate representation, and each element s_{i,j} of S represents the score corresponding to the i^{th} block output position and the j^{th} block input position.

6. The system of claim 1, wherein:
applying the intermediate representation to the block input sequence to generate the block output sequence comprises computing:
Y=softmax(S)·X
wherein Y∈ [symbol] ^{M×D} represents the block output sequence, X∈ [symbol] ^{N×D} represents the block input sequence, and S∈ [symbol] ^{M×N} represents the intermediate representation.

7. The system of claim 1, wherein the sequence of network blocks comprises a plurality of merger network blocks, wherein each particular merger network block is configured to generate a block output sequence having a shorter length than the respective block output sequences of any other merger network blocks that precede the particular merger network block in the sequence of network blocks.

8. The system of claim 1, wherein the merger network block is configured to obtain a block input sequence comprising a variable number N of block input elements and to generate a block output sequence having a predetermined number M of block output elements.

9. The system of claim 1, wherein the neural network is configured to perform a first machine learning task, and wherein the neural network has been pre-trained to perform a second machine learning task that is different than the first machine learning task.

10. The system of claim 9, wherein the input sequences corresponding to the first machine learning task have more input elements than the input sequences corresponding to the second machine learning task.

11. The system of claim 1, wherein:
the input sequence represents an input image, and at least some of the input elements represent respective image patches determined from the input image,
the input sequence represents an input text, and at least some of the input elements represent respective text tokens determined from the input text, or
the input sequence represents audio data, and at least some of the input elements represent respective audio tokens determined from the audio data.

12. The system of claim 1, wherein the sequence of network blocks further comprises a self-attention network block that is configured to perform operations comprising:
obtaining a second block input sequence having a respective second block input element at only each of P second block input positions, P>1; and
applying self-attention to the second block input sequence to generate a second block output sequence having a respective second block output element at only each of P second block output positions.

13. The system of claim 1, wherein the sequence of network blocks further comprises an expert network block that is configured to perform operations comprising:
obtaining a third block input sequence having a respective third block input element at only each of Q third block input positions, Q>1;
for each of a plurality of expert subnetworks of the expert network block:
determining a subset of the third block input elements; and
for each third block input element in the subset, processing the third block input element using the expert subnetwork to generate a respective sub-output; and
generating a third block output sequence having a respective third block output element at only each of Q third block output positions, comprising:
for each third block input element, determining a respective third block output element from the sub-outputs generated from the third block input element.

14. The system of claim 1, wherein the neural network further comprises a layer normalization neural network layer preceding the merger network block, wherein the layer normalization neural network layer is configured to perform operations comprising:
obtaining an initial block input sequence having a respective initial block input element at only each of the N block input positions; and
applying layer normalization to each initial block input element in the initial block input sequence to generate the block input sequence.

15. (canceled)

16. One or more non-transitory computer storage media storing instructions that when executed by one or more computers cause the one more computers to perform implement a neural network that is configured to process an input sequence comprising a respective input element at each of a plurality of input positions and to generate a network output representing the input sequence,
the neural network comprising a sequence of one or more network blocks, the sequence comprising a merger network block configured to perform operations comprising:
obtaining a block input sequence having a respective block input element at only each of N block input positions, wherein N>1; and
processing the block input sequence to generate a block output sequence having a respective block output element at only each of M block output positions, wherein N>M>1,
the processing comprising:
applying a learned weight matrix to the block input sequence to generate an intermediate representation comprising, for each block output position, a respective score corresponding to each block input position, and
applying the intermediate representation to the block input sequence to generate the block output sequence.

17. A method performed by one or more computers the method comprising:
receiving an input sequence comprising a respective input element at each of a plurality of input positions; and
processing the input sequence using a neural network to generate a network output representing the input sequence,
the neural network comprising a sequence of one or more network blocks, the sequence comprising a merger network block configured to perform operations comprising:
obtaining a block input sequence having a respective block input element at only each of N block input positions, wherein N>1; and
processing the block input sequence to generate a block output sequence having a respective block output element at only each of M block output positions, wherein N>M>1,
the processing of the block input sequence comprising:
applying a learned weight matrix to the block input sequence to generate an intermediate representation comprising, for each block output position, a respective score corresponding to each block input position, and
applying the intermediate representation to the block input sequence to generate the block output sequence.

18. The method of claim 17, wherein:
the block input sequence is represented as an input matrix X∈ [symbol] ^{N×D}, wherein each row of the input matrix represents a respective block input element xⱼ∈ [symbol] ^{D}, j∈[1, . . . , N].

19. The method of claim 17, wherein:
the block output sequence is represented as an output matrix Y∈ [symbol] ^{M×D}, wherein each row of the output matrix represents a respective block output element yᵢ∈ [symbol] ^{D}, i∈[1, . . . , M].

20. The method of claim 17, wherein:
applying a learned weight matrix to the block input sequence to generate an intermediate representation comprises computing:
S=(XW)^{T}
wherein X∈ [symbol] ^{N×D} represents the block input sequence, W∈ [symbol] ^{D×M} represents the learned weight matrix, S∈ [symbol] ^{M×N} represents the intermediate representation, and each element s_{i,j} of S represents the score corresponding to the i^{th} block output position and the j^{th} block input position.

21. The method of claim 17, wherein:
applying a learned weight matrix to the block input sequence to generate an intermediate representation comprises computing:
S=W^{T}X^{T}
wherein X∈ [symbol] ^{N×D} represents the block input sequence, W∈ [symbol] ^{D×M} represents the learned weight matrix, S∈ [symbol] ^{M×N} represents the intermediate representation, and each element s_{i,j} of S represents the score corresponding to the i^{th} block output position and the j^{th} block input position.
